(19) United States
(12) Patent Application Publication
(10) Pub. No.: US 2024/0286366 A1
(43) Pub. Date: Aug. 29, 2024

(54) FIBER-REINFORCED METAL COMPOSITE MEMBER AND MANUFACTURING METHOD THEREOF

(71) Applicant: SHENZHEN UNIVERSITY, Shenzhen, Guangdong (CN)

(72) Inventors: Yufei WU, Shenzhen (CN); Zilong ZHAO, Shenzhen (CN); Pengda LI, Shenzhen (CN)

(73) Assignee: SHENZHEN UNIVERSITY, Shenzhen, Guangdong (CN)

(21) Appl. No.: 18/571,564

(22) PCT Filed: Jan. 26, 2022
(86) PCT No.: PCT/CN2022/073968

§ 371 Date: Dec. 18, 2023

(30) Foreign Application Priority Data
Jun. 23, 2021 (CN) 202110699780.3

(51) Int. Cl. B29C 70/68; B29K 105/06

(52) U.S. Cl. CPC B29C 70/682; B29C 70/683; B29K 2105/06; B29K 2905/00

(57) ABSTRACT

A fiber-reinforced metal composite member and a manufacturing method thereof. The member includes a metallic matrix provided with a plurality of grooves thereon at a preset angle to a horizontal direction, and the grooves are filled with fiber-reinforced polymers therein. Based on the characteristic that deformation at a necking-occurring location of metal material increases but tensile bearing capacity decreases while bearing capacity of the fiber-reinforced polymers increases with their tensile deformation increasing, the embodiments include fiber-reinforced polymers in the grooves with preset angle and metal to jointly bear the effect of tensile, so at the necking-occurring location, bearing capacity of fiber-reinforced polymers increases to compensate for the decrease of bearing capacity of metal material, thereby avoiding occurring necking or making necking to occur at multiple locations, preventing metal composite member from fracturing due to occurring local necking at one location, and improving deformability of metal composite member.

### FIELD

The present disclosure relates to the technical field of composite materials, in particular to a fiber-reinforced metal composite member and a manufacturing method thereof.

### BACKGROUND

Metal materials refer to a general designation for materials with metallic characteristics composed of metal elements or mainly composed of metal elements, including pure metals, alloys, intermetallic compounds, and special metal materials. Metal materials have become essential basic materials and important strategic materials for the economy, people's daily life, and development of science and technology.

Necking refers to a phenomenon of local cross-sectional reduction of a material under tensile stress. Existing metal materials are prone to fracture at local necking locations when under tensile stress.

Therefore, the prior art still needs to be improved and developed.

### SUMMARY

The technical problem to be solved by the present disclosure is, for the aforementioned necking problem in the prior art, to provide a fiber-reinforced metal composite member and a manufacturing method thereof, aiming to solve the problem that the existing metal materials are prone to fracture due to necking at local locations when under tensile stress.

The technical scheme of the present disclosure to solve the problem is as follows:

In one aspect, the embodiments of the present disclosure provide a fiber-reinforced metal composite member, the fiber-reinforced metal composite member comprises a metallic matrix, the metallic matrix is provided with a plurality of grooves at a preset angle to a horizontal direction, the plurality of grooves are filled with fiber-reinforced polymers.

In the fiber-reinforced metal composite member, the preset angle is preferably 15°˜60° or 120°˜165°.

In the fiber-reinforced metal composite member, an ultimate strain of the fiber-reinforced polymers is 1%˜15%.

In the fiber-reinforced metal composite member, the plurality of grooves have a same shape, and the cross-section of the groove is any shape such as a circle, a square, or a rectangle.

In the fiber-reinforcement metal composite member, the plurality of grooves are arranged on a surface of the metallic matrix, and the plurality of grooves are arranged with equal intervals along a longitudinal direction of the metallic matrix.

In the fiber-reinforced metal composite member, the plurality of grooves are arranged inside the metallic matrix.

In the fiber-reinforced metal composite member, the preset angle, a content of the fiber-reinforced polymers, and an elastic modulus of the fiber-reinforced polymers meet a criterion that the cross-sectional resistance of the composite member keep hardening without softening before the rupture of the metallic matrix or the fiber-reinforced polymers.

In another aspect, the embodiments of the present disclosure provide a manufacturing method for the fiber-reinforced metal composite member mentioned above, the method comprises steps:

Forming the plurality of grooves on the metallic matrix at the preset angle to the horizontal direction, and selecting the fiber-reinforced polymers that meet a predetermined properties of the fiber-reinforced polymers:

Filling the fiber-reinforced polymers that meet a predetermined content of the fiber-reinforced polymers into the plurality of grooves, obtaining the fiber-reinforced metal composite member.

In the manufacturing method for the fiber-reinforced metal composite member, before the step of forming the plurality of grooves on the metallic matrix at the preset angle to the horizontal direction, the method comprises steps:

Designing the content, preset angle of fiber-reinforced polymers so that the cross-sectional resistance of the composite member keep hardening before the rupture of the metallic matrix or the fiber-reinforced polymers.

In the manufacturing method for the fiber-reinforced metal composite member, before the step of filling the fiber-reinforced polymers that meet the predetermined content of the fiber-reinforced polymers into the plurality of grooves, the method comprises steps:

Sandblasting a surface of the plurality of grooves and/or a surface of the metallic matrix.

Beneficial effects of the present disclosure: The metal composite member of the present disclosure utilizes the fiber-reinforced polymers in the plurality of grooves with preset angles to jointly bear tensile stress, to avoid local necking or to occur necking at different locations of the whole metal composite member, and to prevent the metal composite material from fracturing due to occurring local necking at one location, and improve deformability of the metal composite material.

### BRIEF DESCRIPTION OF THE DRAWINGS

In order to more clearly explain the embodiments of the present disclosure or the technical solutions in the prior art, a brief introduction for the accompanying drawings required in the description of the embodiments or prior art is given below. Obviously, the accompanying drawings in the following description are only some of the embodiments recorded in the present disclosure. For ordinary skilled in the art, other accompanying drawings can be obtained based on these drawings without any creative effort.

FIG. 1 is a schematic diagram showing a structure of a fiber-reinforced metal composite member provided in the embodiments of the present disclosure.

FIG. 2 is a schematic diagram showing a local engineering stress-strain curve of a necking cross-section corresponding to a metallic matrix provided in the embodiments of the present disclosure.

FIG. 3 is a sectional view showing the fiber-reinforced metal composite member when setting a plurality of grooves provided in the embodiments of the present disclosure inside the metallic matrix.

FIG. 4 is a schematic diagram showing a stress-strain curve of the metal composite member provided in a first embodiment and a second embodiment of the present disclosure.

### DETAILED DESCRIPTION OF EMBODIMENTS

In order to make the purposes, technical solutions, and beneficial effects of the present disclosure clearer and more definite, the present disclosure is further described in detail below with reference to the accompanying drawings and embodiments. It should be understood that the embodiments described here are only used to explain the present disclosure, not to limit the present disclosure.

It should be noted that if there is a directional indication (such as up, down, left, right, front, or rear . . . ) involved in the embodiments of the present disclosure, the directional indication is only used to explain a relative location relationship, a motion state, etc. between components in a specific posture (as shown in the accompanying drawings). If the specific posture changes, the directional indication also changes accordingly.

The necking refers to a phenomenon of local cross-sectional reduction of a material under tensile stress. Due to small differences in effective cross-sectional area, existing metal materials are prone to fracture at local necking locations when under tensile stress, indicating poor deformability of the existing metal materials. In order to improve strength of a metal material, an existing method directly wraps carbon fiber-reinforced polymers (CFRP) or glass fiber-reinforced polymers (GFRP) on exterior surface of the metal material. Although the existing method can improve the strength of the whole metal material, when an ultimate strain of the fiber-reinforced polymers is reached, the fiber-reinforced polymer outside the metal material fractures. A fracture of the metal material is determined by the fiber-reinforced polymers, and although the strength of the metal material has increased, their ductility has not increased.

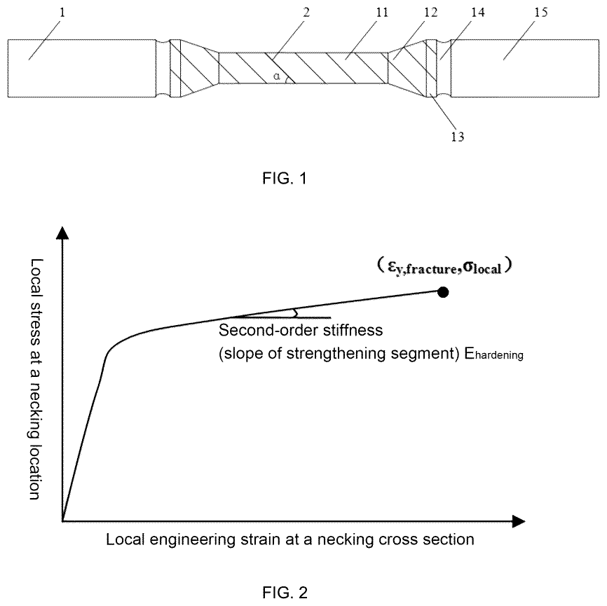

In order to solve problems of the prior art, the present embodiment provides a fiber-reinforced metal composite member, as shown in FIG. 1. The metal composite member comprises: a metallic matrix 1, which has a plurality of grooves 2 provided thereon, the plurality of grooves 2 are at a preset angle to a horizontal direction, and are filled with fiber-reinforced polymers. Based on a characteristic that a deformation of the metal material at a necking-occurring location increases but a tensile bearing capacity decreases, while a bearing capacity of the fiber-reinforced polymers increases with an increase of their tensile deformation, the present disclosure has the fiber-reinforced polymers in the plurality of grooves with the preset angle and the metal to jointly bear the effect of tensile force, so at the necking-occurring location, the bearing capacity of the fiber-reinforced polymers increases to compensate for the decrease of the bearing capacity of the metal material, thereby avoiding occurring necking or occurring necking at multiple locations, preventing the metal composite member from fracturing due to occurring local necking at one location, and improving deformability of the metal composite member.

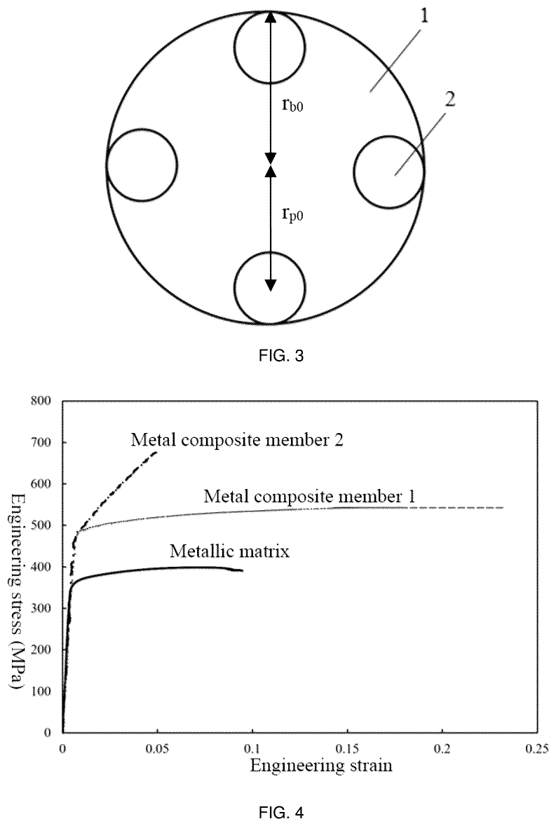

In one embodiment, the preset angle, a content of the fiber-reinforced polymers and an elastic modulus of the fiber-reinforced polymers meet a criterion that the cross-sectional resistance of the composite member keep hardening without softening before the rupture of the metallic matrix or the fiber-reinforced polymers. As shown in FIG. 3, rₚₒ is a distance from a center of the metallic matrix to a center of the fiber-reinforced polymers, r_{bo} is a radius of the metallic matrix. As shown in FIG. 2, ε_{y,fracture}, σ_{local}(ε_{y,fracture}) and E_{hardening} are determined by the local engineering stress-strain curve at a necking cross section corresponding to the metallic matrix, ε_{y,fracture} is an axial-local axial fracture strain at a necking location, σ_{local}(ε_{y,fracture}) is a cross-sectional local stress corresponding to the axial local fracture strain at the necking location ε_{y,fracture}. E_{hardening} is a slope of a strengthening segment of the local engineering stress-strain curve of the necking cross section. As shown in FIG. 2, FIG. 2 is the local engineering stress-strain curve at the necking cross section corresponding to the metallic matrix 1, the ε_{y,fracture}, the σ_{local}(ε_{y,fracture}) and the E_{hardening} can be determined from the local engineering stress-strain curve of the necking cross section corresponding to the metallic matrix 1. For the metallic matrix 1 with known material and shape, the initial cross-sectional area of the metallic matrix Aₘₑₜₐₗ, the axial local fracture strain at the necking location ε_{y,fracture}, the cross-sectional local stress σ_{local}(ε_{y,fracture}) and the slope of the strengthening segment E_{hardening} are known, thus the elastic modulus of the fiber-reinforced polymers E_{frp}, the preset angle α, and the content of the fiber-reinforced polymers A_{frp} can be determined based on the criteria. In the present embodiment, the plurality of grooves 2, that are at the preset angle to the horizontal direction, are provided on the metallic matrix 1 and are filled with the fiber-reinforced polymers. When the metal composite member occurs necking subjected to tensile stress, the metallic matrix bears the tensile force effect jointly with the fiber-reinforced polymers in the plurality of grooves 2 with the preset angle, to avoid necking or to make the whole metal composite member occur necking at multiple locations, to prevent the metal composite member from fracturing due to occurring local necking at one location, and to improve the deformability of the metal composite member.

In one embodiment, the initial cross-sectional area of the metallic matrix 1 Aₘₑₜₐₗ refers to a corresponding cross-sectional area on the axial plane when the metallic matrix 1 is not subjected to tensile stress, which is related to an initial cross-sectional shape of the metallic matrix 1. For example, when the initial cross-sectional shape of the metallic matrix 1 on the axial plane is circular, the initial cross-sectional area Aₘₑₜₐₗ is a circular area, and when the initial cross-sectional shape of the metallic matrix 1 on the axial plane is rectangular or square, the initial cross-sectional area Aₘₑₜₐₗ is a rectangular area or a square area.

Continuing to refer to FIG. 1, the plurality of grooves 2 are provided on a surface of the metallic matrix 1, the plurality of grooves 2 are provided with equal intervals along a longitudinal direction of the metallic matrix 1. The preset angle α is an angle between a longitudinal direction of each groove 2 and the horizontal direction. The preset angle α between each groove 2 and the horizontal direction is preferably 15°˜ 60° or 120°˜165°. The preset angle α between each groove 2 and the horizontal direction may be the same, for example, the preset angle α between each groove 2 and the horizontal direction is 30° or 35° or 45°, etc.; the preset angle α between each groove 2 and the horizontal direction may be different, for example, the metallic matrix 1 has three grooves 2 provided thereon, wherein one groove 2 has a preset angle α with the horizontal direction of 30°, another groove 2 has a preset angle α with the horizontal direction of 35°, and a third groove 2 has a preset angle α with the horizontal direction of 45°, or two of the grooves 2 have a preset angle α with the horizontal direction of 30°, and another groove 2 has a preset angle α with the horizontal direction of 35°. Setting the preset angle α between the plurality of grooves 2 and the horizontal direction within the above range enables the fiber-reinforced polymers in the plurality of grooves 2 to jointly bear the tensile stress when metal composite material is subjected to tensile stresses, thereby avoiding necking or occurring necking at different locations of the whole metal composite member, preventing the metal composite material from fracturing due to local necking at one location.

As shown in FIG. 3, in one embodiment of the present disclosure, a plurality of grooves 2 are arranged inside the metallic matrix 1, and the plurality of grooves 2 penetrate through one end of the metallic matrix 1. When filling the fiber-reinforced polymers, the fiber-reinforced polymers are inserted into the plurality of grooves along one end of the metallic matrix 1. When the metal composite member is subjected to tensile stress and necking occurs, the metallic matrix bears the tensile stress effect jointly with the fiber-reinforced polymers in the plurality of grooves 2 with preset angles, to prevent the metal composite material from fracturing due to local necking at one location, and improve the deformability of the metal composite material.

In one embodiment, shapes of the plurality of grooves 2 can be set as needed, and cross-sectional shapes of the plurality of grooves 2 may be circular, square, or rectangular. An opening width of each groove 2 is 2.5-3.0 mm, and a sandblasting treatment is performed on surfaces where the plurality of grooves 2 make contact with the fiber-reinforced polymers. By setting the opening width of the groove 2 within the above range and setting the sandblasting layers on the contact surfaces between the grooves 2 and the fiber-reinforced polymers, it is possible to bond the fiber-reinforced polymers more firmly with the plurality of grooves 2, avoiding the fiber-reinforced polymers from sliding out of the grooves 2.

In one embodiment, the volume of the fiber-reinforced polymers filled in each groove 2 is equal to the volume of each groove 2, i.e. the plurality of the grooves 2 are completely filled with the fiber-reinforced polymers and a sum of the volume of each groove 2 is from 35% to 55% of a volume of the metallic matrix 1. The fiber-reinforced polymers have an elastic modulus of 8˜20 GPa, and the fiber-reinforced polymers have an ultimate strain of 1%˜15%, which enables to limit deformation of necking areas through a cooperation of preset angles and the fiber-reinforced polymers meeting the elastic modulus and the ultimate strain, making necking to occur in multiple locations on the whole metal composite member, and preventing the metal composite material from fracturing due to local necking at one location.

Continuing to refer to FIG. 1, the metallic matrix 1 may be pure metal, alloy, intermetallic compound, special metal material, etc. The metallic matrix 1 may be a circular rib or plate. The metallic matrix 1 includes a first metal component 11, a second metal component 12, a third metal component 13, a fourth metal component 14, and a fifth metal component 15. The second metal component 12, the third metal component 13, the fourth metal component 14 and the fifth metal component 15 are all arranged as two. The two second metal components 12 are respectively connected to two ends of the first metal component 11, and the two third metal components 13 are respectively connected to the two second metal components 12, and the two fourth metal components 14 are respectively connected to the two third metal components 13, and the two fifth metal components 15 are respectively connected to the two fourth metal components 14 to form an example of the metallic matrix. A longitudinal section of the first metal component 11 is a rectangle, and a longitudinal section of the second metal component 12 is a trapezoid. An upper bottom of the trapezoid is connected to the first metal component 11, and a lower bottom of the trapezoid is connected to the third metal component 13. A longitudinal section of the third metal component 13 is a rectangle, and the plurality of grooves 2 are arranged on the first metal component 11, the second metal component 12, and the third metal component 13. An outer surface of the fourth metal component 14 is concave towards a longitudinal direction of the metallic matrix, and a longitudinal section of the fifth metal component 15 is a rectangle. Through the fourth metal component 14, the fiber-reinforced polymers in the plurality of grooves 2 can be anchored.

In one embodiment, the first metal component 11, the second metal component 12, the third metal component 13, the fourth metal component 14, and the fifth metal component 15 have a length ratio of 100:20:4:4:62 along the longitudinal direction of the metallic matrix. For example, the first metal component 11 has a length of 100 mm along the longitudinal direction of the metallic matrix, the second metal component 12 has a length of 20 mm along the longitudinal direction of the metallic matrix, the third metal component 13 has a length of 4 mm along the longitudinal direction of the metallic matrix, the fourth metal component 14 has a length of 4 mm along the longitudinal direction of the metallic matrix, the fifth metal component 15 has a length of 62 mm along the longitudinal direction of the metallic matrix.

Based on the above-mentioned fiber-reinforced metal composite member, the present disclosure also proposes a method for manufacturing the fiber-reinforced metal composite member, the method includes:

Step S100, forming a plurality of grooves on a metallic matrix at a preset angle to a horizontal direction, and selecting fiber-reinforced polymers meeting a predetermined elastic modulus of the fiber-reinforced polymers:

Step S200, filling the plurality of grooves with the fiber-reinforced polymers in a predetermined content of the fiber-reinforced polymers to obtain a fiber-reinforced metal composite member.

In one embodiment, in order to manufacture the above-mentioned fiber-reinforced metal composite member, in the present embodiment, a plurality of grooves at preset angles to a horizontal direction are first opened on a metal matrix, and fiber-reinforced polymers that meet an elastic modulus of the fiber-reinforced polymers are selected, then the fiber-reinforced polymers meet a content of the fiber-reinforced polymers are filled in the plurality of grooves to obtain the fiber-reinforced metal composite member. In the present embodiment, due to forming the plurality of grooves on the metal matrix at the preset angle to the horizontal direction, and filling the fiber-reinforced polymers in the plurality of grooves, when the metal composite member occurs necking under tensile stress, the fiber-reinforced polymers in the plurality of grooves with the preset angles jointly with the metallic matrix bear tensile stress, avoiding necking or making necking to occur at different locations of the whole metal composite member, preventing the metal composite material from fracturing due to local necking at one location, and improving the anti-deformability of the metal composite material.

In one embodiment, prior to step S100 includes:

Step M100, obtaining a local engineering stress-strain curve of a necking cross section corresponding to the metal matrix, and determining an axial local fracture strain at a necking location according to the local engineering stress-strain curve of the necking cross section, a cross-sectional local stress corresponding to the axial local fracture strain at the necking location, and a slope of a strengthening segment of the local engineering stress-strain curve of the necking cross section:

Step M200, obtaining an initial cross-sectional area of the metallic matrix, and determining an elastic modulus of the fiber-reinforced polymers, a preset angle, and a content of the fiber-reinforced polymers based on the initial cross-sectional area, the axial local fracture strain at the necking location, the cross-sectional local stress, and the slope of the strengthening segment. That is, designing the content and preset angle of fiber-reinforced polymers so that the cross-sectional resistance of the composite member keeps hardening before the rupture of the metallic matrix or the fiber-reinforced polymers. As shown in FIG. 3, rₚₒ is a distance from a center of the metallic matrix to a center of the fiber-reinforced polymers, r_{bo} is a radius of the metallic matrix. As shown in FIG. 2, ε_{y,fracture}, σ_{local} (ε_{y,fracture}) and E_{hardening} are determined by the local engineering stress-strain curve of the necking cross section corresponding to the metallic matrix, ε_{y,fracture} is the axial-local axial fracture strain at the necking location, σ_{local} (ε_{y,fracture}) is the cross-sectional local stress corresponding to the axial local fracture strain at the necking location ε_{y,fracture}. E_{hardening} is the slope of the strengthening segment of the local engineering stress-strain curve of the necking cross section.

In the present embodiment, when manufacturing the metal composite member, first selecting a metallic matrix to be reinforced, determining an axial fracture strain at a necking location, a cross-sectional local stress corresponding to the axial fracture strain at the necking location, and a slope of a strengthening segment of a local engineering stress-strain curve of the necking cross section according to the local engineering stress-strain curve of the necking cross section corresponding to the metallic matrix. As shown in FIG. 2, FIG. 2 is the local engineering stress-strain curve of the necking cross section corresponding to the metallic matrix. The axial fracture strain at the necking location ε_{y,fracture} refers to an axial local fracture strain at the necking location, the cross-sectional local stress σ_{local} (ε_{y,fracture}) corresponding to the axial fracture strain ε_{y,fracture} at the necking location refers to a cross-sectional local stress of the metallic matrix when the metallic matrix undergoes the axial fracture strain at the necking location ε_{y,fracture}. ε_{y,fracture}, σ_{local} (ε_{y,fracture}) and the slope of the strengthening segment of the local engineering stress-strain curve of the necking cross section E_{hardening} can be determined by the local engineering stress-strain curve of the necking cross section corresponding to the metallic matrix.

Obtaining an initial cross-sectional area of the metallic matrix after determining the axial fracture strain at the necking location, the cross-sectional local stress and the slope of the strengthening segment. And determining an elastic modulus of the fiber-reinforced polymers, a preset angle, and a content of the fiber-reinforced polymers according to the initial cross-sectional area, the axial fracture strain at the necking location, the cross-sectional local stress, and the slope of the strengthening segment. That is, designing the content and preset angle of fiber-reinforced polymers so that the cross-sectional resistance of the composite member keeps hardening before the rupture of the metallic matrix or the fiber-reinforced polymers.

Forming a plurality of grooves on the metallic matrix according to the preset angle after determining the elastic modulus of the fiber-reinforced polymers, the preset angle, and the content of the fiber-reinforced polymers, and filling fiber-reinforced polymers that meet the content of the fiber-reinforced polymers and the elastic modulus of the fiber-reinforced polymers in the plurality of grooves. Then, fixing the fiber-reinforced polymers in the plurality of grooves to obtain a fiber-reinforced metal composite member.

In order to make the fiber-reinforced polymers bond more firmly, in the present embodiment, before filling the fiber-reinforced polymers with the content of the fiber-reinforced polymers into the plurality of grooves, a sandblasting treatment is performed on surfaces of the plurality of grooves and/or the metallic matrix. After the sandblasting treatment, filling the fiber-reinforced polymers into the plurality of grooves and fixing the fiber-reinforced polymers. In one embodiment, glue may be used to fix the fiber-reinforced polymers in the plurality of grooves, and the glue may be architectural structural glue or organic glue such as epoxy resin glue.

### Embodiment 1

Forming a plurality of grooves on a metallic matrix at a 45° angle to the horizontal direction, and filling the grooves with large rupture strain fiber-reinforced polymers (LRS-FRP) with an elastic modulus of 8 GPa and an ultimate strain of 10%, obtaining a metal composite member 1 based on fiber reinforcement.

### Embodiment 2

Forming a plurality of grooves on a metallic matrix at a 30° angle to the horizontal direction, and filling the grooves with glass fiber-reinforced polymers (GFRP) with an elastic modulus of 55 GPa and an ultimate strain of 3%, obtaining a metal composite member 2 based on fiber reinforcement.

Using a tensile testing machine to conduct tensile tests on the metal composite member 1, the metal composite member 2, and the metal matrix, obtaining a stress-strain curve shown in FIG. 4. From FIG. 4, it can be seen that the strength of the metal composite member 2 is significantly improved compared to that of the metallic matrix, but ductility of the metal composite member 2 remains relatively smaller than others. Strength and ductility of the metal composite member 1 are significantly improved compared to that of the metallic matrix.

In summary, the present disclosure provides a fiber-reinforced metal composite member and a manufacturing method thereof, the fiber-reinforced metal composite member includes a metallic matrix, wherein the metallic matrix is provided with a plurality of grooves thereon at a preset angle to a horizontal direction, and the plurality of grooves are filled with fiber-reinforced polymers. Based on a characteristic that a deformation at a necking-occurring location of the metal material increases with a tensile bearing capacity decreasing, while a bearing capacity of the fiber-reinforced polymers increases with an increase of their tensile deformation, the present disclosure has the fiber-reinforced polymers in the plurality of grooves at the preset angle and the metal to jointly bear the effect of tensile stress, so at the necking-occurring location, the bearing capacity of the fiber-reinforced polymers increases to compensate for the decrease of the bearing capacity of the metal material, thereby avoiding occurring necking or making necking to occur at multiple locations, preventing the metal composite member from fracturing due to occurring local necking at one location, and improving deformability of the metal composite member.

It should be understood that the application of the present disclosure is not limited to the above embodiments. For ordinary skilled in the art, improvements or transformations can be made according to the above description, and all these improvements and transformations should fall within the protection scope of the claims attached to the present disclosure.

1-10. (canceled)

11. A fiber-reinforced metal composite member, comprising: a metallic matrix, the metallic matrix is provided with a plurality of grooves at a preset angle to a horizontal direction, and the plurality of grooves are filled with fiber-reinforced polymers.

12. The fiber-reinforced metal composite member according to claim 11, wherein the preset angle is 15°˜60° or 120°˜165°.

13. The fiber-reinforced metal composite member according to claim 11, wherein an ultimate strain of the fiber-reinforced polymers is 1%˜15%.

14. The fiber-reinforced metal composite member according to claim 11, wherein each of the plurality of grooves have a same shape, and a cross-sectional shape of the plurality of grooves is one of a circle, a square, or a rectangle.

15. The fiber-reinforced metal composite member according to claim 11, wherein the plurality of grooves are arranged on a surface of the metallic matrix, and the plurality of grooves are arranged with equal intervals along a longitudinal direction of the metallic matrix.

16. The fiber-reinforced metal composite member according to claim 11, wherein the plurality of grooves are arranged inside the metallic matrix.

17. The fiber-reinforced metal composite member according to claim 11, wherein the preset angle, a content of the fiber-reinforced polymers, and an elastic modulus of the fiber-reinforced polymers meet a criterion that a cross-sectional resistance of the fiber-reinforced metal composite member hardens before a rupture of metallic matric or the fiber-reinforced polymers.

18. A manufacturing method for the fiber-reinforced metal composite member according to claim 11, comprising:
forming the plurality of grooves on the metallic matrix at the preset angle to the horizontal direction, and selecting the fiber-reinforced polymers that meet a predetermined content and elastic modulus of the fiber-reinforced polymers; and
filling the fiber-reinforced polymers that meet the predetermined content of the fiber-reinforced polymers into the plurality of grooves, obtaining the fiber-reinforced metal composite member.

19. The manufacturing method for the fiber-reinforced metal composite member according to claim 18, wherein before forming the plurality of grooves on the metallic matrix at the preset angle to the horizontal direction, the method further comprises:
designing a cross-sectional resistance of the fiber-reinforced metal composite member so that the cross-sectional resistance of the composite member keeps hardening until a rupture of metallic matrix or the fiber-reinforced polymers.

20. The manufacturing method of the fiber-reinforced metal composite member according to claim 18, wherein before filling the fiber-reinforced polymers that meet the predetermined content of the fiber-reinforced polymers into the plurality of grooves, the method further comprises:
sandblasting a surface of the plurality of grooves and/or a surface of the metallic matrix.
